(19) United States
(12) Patent Application Publication
(10) Pub. No.: US 2023/0262079 A1
(43) Pub. Date: Aug. 17, 2023

(54) SYSTEM AND A METHOD FOR GENERATING TRUSTED URLs

(71) Applicant: Michael FELDBAU, Petah Tiqwa (IL)

(72) Inventor: Michael FELDBAU, Petah Tiqwa (IL)

(21) Appl. No.: 18/103,088

(22) Filed: Jan. 30, 2023

(30) Foreign Application Priority Data
Feb. 10, 2022 (IL) 290541

(51) Int. Cl. H04L 9/40; G06F 16/955

(52) U.S. Cl. CPC H04L 63/1425; G06F 16/9566; H04L 63/083; H04L 63/101

(57) ABSTRACT

Systems and methods for generating and using trusted URLs, specifically, secured, trusted, and easy-to-use anti-phishing URLs to simplify the defense process against malicious URLs, make it easier to verify URLs′ legitimacy and increase confidence in them.

### CROSS REFERENCE TO RELATED APPLICATIONS

This application claims the benefit of priority of Israeli Patent Application No. 290541, filed on Feb. 10, 2022, the contents of which are incorporated herein by reference in their entirety.

### FIELD OF THE INVENTION

The present invention is in the field of internet links and addresses and, more specifically, secured, trusted, and easy-to-use anti-phishing URLs.

### BACKGROUND

Any Internet resource such as documents, Web pages, images, audio, video, etc., has a location whose address on the Internet is specified by a URL (Uniform Resource Locator).

Communicating with clients, customers, or otherwise associated parties often involves an online interaction that requires sending them URLs to web pages, forms, or other Web resources. However, this clashes with the Phishing problem.

Phishing is a major well-known problem. Millions of messages of any form (e.g., e-mail, SMS, Twitter, WhatsApp, and Messenger, etc.) are spread daily with malicious URLs, which are intended to mislead innocent users into believing they are legitimate while actually trying to steal the users’ information, money or identity.

Numerous solutions exist to reduce the problem’s impact, but they mostly put the burden of defense on the end-user, require understanding of computer and Internet jargon and terminology, familiarity with software installation and operation, analysis of addresses and acquaintance with various service providers’ domain names, and many other skills - which most people lack.

Currently the basic approach to dealing with malicious links in general and the Phishing problem in particular, involves checking public “Blacklists”, which are lists updated frequently with newly reported malicious URLs. After reporting such malicious URL, it is analyzed and checked, and if found harmful it is added to the Blacklists.

The main problems associated with that approach are threefold:
(i) The time passed since the moment of publication of the malicious URL and until it reaches the Blacklists is measured in days. Meanwhile millions of malicious URLs were already widely spread and acted upon;
(ii) Special application packages that scan the Blacklists are required to be installed and used, which either people aren’t aware of, or cost money and are complicated to operate for most users, facts which deter people from using them;
(iii) Many URLs are shortened using services such as bit.ly (bitly.com), making the target URL unreadable and confusing for the common users.

Service providers are aware of the phishing problem but they feel frustrated as well being unable to efficiently protect their customers and users, and worse yet that users are exposed to fraudsters.

A strong need therefore exists for a system and method which shall simplify the safety and security process, and make it accessible and available to everybody.

### PRIOR PUBLICATIONS

URL shortening is a technique that allows a URL to be represented by a shorter representation. The original target URL is recorded with a server associated with the shortening service. The shorter URL always has a predetermined domain name e.g.: “bit.ly”, which directs it to a specific shortening server. Once the short URL is clicked, it reaches the server where it is used to locate the recorded target URL, to which it is eventually redirected.

Typically, a short URL is used to significantly reduce the target URL string length to cut its container messages size which is sometimes limited. However, since a short URL actually obscures the target URL, URL shortening could and is actually being misused by fraudsters, who disguise the target URL to mislead users.

It is emphasized that the user who clicks the short URL is indifferent to the domain name. He doesn’t care if the domain name is “Bit.ly” or “L5k.me”. The only interested entity is the owner of the target URL which wishes to shorten the target URL string as much as possible. This indifference property attributed to the end-user will be addressed and take an important role later on in the text.

Short URLs are also used to track user’s traffic to the target URL and provide statistics and analytics data.

URL shortening technic itself is well known and published in numerous patent and non-patent publications.

US6957224, for example, describes a system, method, and computer program product for providing links to remotely located information in a network of remotely connected computers. A uniform resource locator (URL) is registered with a server. A shorthand link is associated with the registered URL. The associated shorthand link and URL are logged-in a registry database. When a request is received for a shorthand link, the registry database is searched for an associated URL. If the shorthand link is found to be associated with a URL, the URL is fetched. Otherwise, an error message is returned.

A notable URL shortening service, TinyURL, was launched as early as 2002 and influenced the creation of dozens of similar services. For example, at first, Twitter used to automatically translate URLs longer than twenty-six characters using TinyURL. Still, later it began using another service (bit.ly) instead, and currently, it uses its own developed URL shortening service - t.co.

Some websites block short, redirected URLs. Popular search engines like Yahoo! and Wikipedia do not accept links from any site that uses URL shortening services. Reddit’s community strongly discourages anyone from submitting links through these services, as they disguise the origin of the link and are not approved by Reddit.

A short URL can be used to obscure a site’s address. It can then be used to redirect a user to an unknown site. ZoneAlarm has warned its users that using TinyURL could expose them to spyware.

To counter this issue, the website provided an option to view a link’s destination before clicking a shortened URL. Although it’s possible to check the destination of a short URL before accessing it, most users are unskilled and would most likely not check it.

Therefore there is still a need in the art for a method that is easy to use and hard to misuse, and that utilizes an easy to spot reliable domain name without the use of bypass monitoring or preview pages all require the end- user to memorize or otherwise know which domains are trustable and which are not, and that is not depended on any already known blacklist.

### SUMMARY OF THE INVENTION

It is therefore an objective of the invention to simplify the defense process against malicious URLs, make it easier to verify URLs′ legitimacy and increase confidence in them. Another objective is to decrease the use of special applications for monitoring URLs. Yet another objective is to make a URL trustworthy immediately upon issuance. An additional objective is to make the URL validation process easy and accessible to the common public without the need for any special skills. Still another objective of the invention is to be able to identify the creators of the URL and hold them accountable for it.

The present invention introduces a trusted system that generates a trusted URL, which is a representation of the original target URL having a special trustworthy system related well-known published domain name. That way, all trusted URLs direct to that specific trusted system. If that system is known to be trustworthy, assuring the legitimacy of the URLs, then instead of compelling end-users to check every time different URLs′ domain names and analyse them to verify their legitimacy, or use special software, it is sufficient for the end-user to verify a single, well-known, trusted URL’s system domain name.

This means that any large number of distinct trusted URLs generated by different clients of that specific trusted URL system, will all have the same domain name, and if that server is trusted to secure and generate legitimate URLs from legitimate identified clients, then the only thing left for end- users to do is to verify that the trusted URL has the trusted system’s well- known published domain name.

As yet, no prior art teaches usage of short URLs for security purposes.

An object of the present invention is to provide a well-known, reliable, trustworthy system for generating trusted URLs by entities known to be legitimate interacting parties such as commercial companies, government institutions, organizations, or otherwise registered and verified entities. By ascertaining that the creator of a URL is known, trusted and verified, users’ confidence in the generated URL may dramatically increase.

Another object of the present invention is to provide a trusted URLs generating system that requires an identification process before and while using the system to generate the trusted URLs.

The present invention discloses a trusted URLs generating method that requires an initial identification and enrolment process for any organization or individual before allowing them to create a user profile within the system and applies an identification or log-in protocol each time the system is being approached and used for generating trusted URLs.

The present invention further discloses a system that uses a predetermined well-known domain name (e.g.: “SecURL.xyz”) which is the domain name of each generated trusted URL (e.g.: “https://SecURL.xyz/L/8dhfH23Gn76”). This domain name could be published and renowned for having strict enrolment, security and identification measures and providing the end-user the confidence to follow the link, by merely checking the link’s domain name, without further checking or monitoring.

As mentioned hereinabove, the end-user who clicks on short URLs is indifferent to the domain name (i.e., to the shortening service provider). In contrast, the present invention is indifferent to the trusted URL string length (subject to usability restrictions e.g. SMS allowed size), while the domain name is of significant importance since it indicates safety and reliability, and should be better verified before clicking on the trusted URL.

### BRIEF DESCRIPTION OF THE DRAWINGS

FIG. 1 shows two main databases of an embodiment of the present application to store and verify the Client’s Agents, which are user entities authorized by Client to register URLs utilizing the system 100, and the Target-URL registry 300 is used to store the Agents’ registered URLs.

FIG. 2 shows a client/agent enrolling process in which an organization enrolls as a client to the system and appoints agents authorized to act on its behalf.

FIG. 3 shows a T-URL generating process in which said Client’s agent registers a target URL in Target-URL Registry 300 and receives a T-URL associated with that target URL to be redirected to the target URL’s internet address.

FIG. 4 shows a redirection process in which the end-user clicks the T-URL sent to him, for example, by the Client, after verifying the T-URL’s domain name and is redirected to its associated target URL address.

FIG. 5 shows an embodiment solving the problem of changing a text part or the address part of a URL or to replace the text part with a picture.

### DETAILED DESCRIPTION OF THE EMBODIMENTS

### Definitions

Client - An organization or individual wishing to register URLs they create and make them trustworthy.
Target URL Registry - a Database for storing URLs registered by a Client (or its authorized Agents).
Agent - A representative authorized by the Client to register Clients’ related URLs in the Target-URL Registry. A machine or device having the required credentials can also act as an Agent.
End-User - a person who receives a URL (e.g., using e-mail, SMS message, Website, etc.) and wishes to trust that URL before clicking on it.
Trusted URL (hereinafter: “T-URL”) - a URL generated by a system or method according to the present invention and representing an associated target URL stored in the Target-URL Registry of the system, and having a preset published and renowned domain name which relates to the system (e.g.: “SecURLxyz”).

The terms “link” and “URL” as well as “system” and “server” are used interchangeably throughout the text and should be interpreted equally. Communicating with clients, customers, or otherwise associated parties often involves an online interaction requiring URLs. Therefore, it is a goal to enable to secure those URLs and allow the receiver to trust and safely interact with the link he was sent.

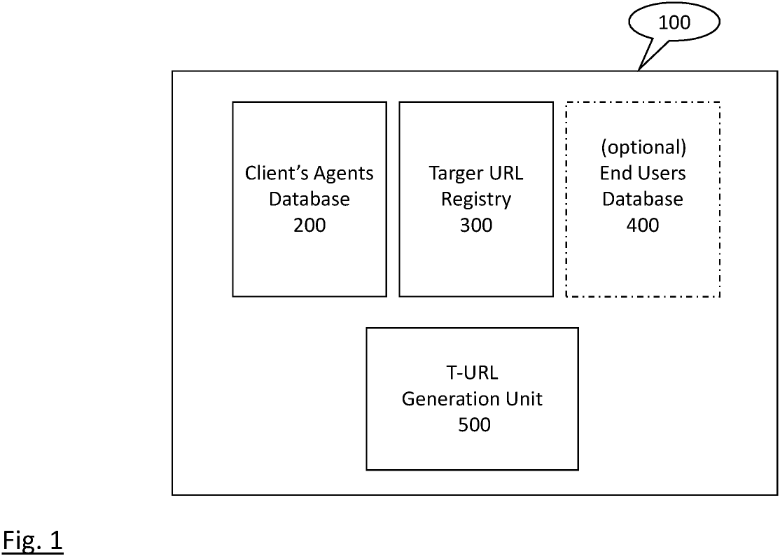

As depicted in FIG. 1, the Trusted URLs system 100 of the present invention comprises two main databases: there is a Client’s agents database 200 and a Target-URL registry 300. In some embodiments, there is an additional end-user database 400.

The Client’s agents database 200 is used to store and verify the Client’s Agents, which are user entities authorized by Client to register URLs utilizing the system 100, and the Target-URL registry 300 is used to store the Agents’ registered URLs.

The T-URL Generation Unit 500 is used to generate T-URLs for URLs registered in Target-URL Registry 300.

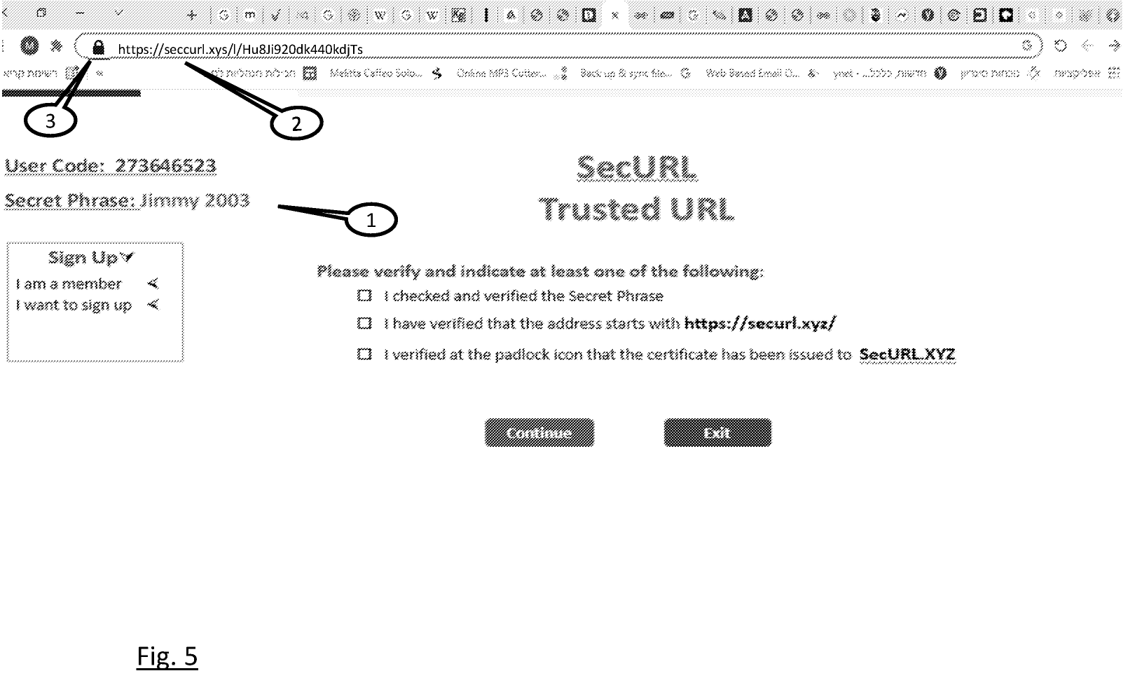

The end-user database 400 is optional and will be explained later on in FIG. 5.

The method of the present invention is based, therefore, on four main processes:

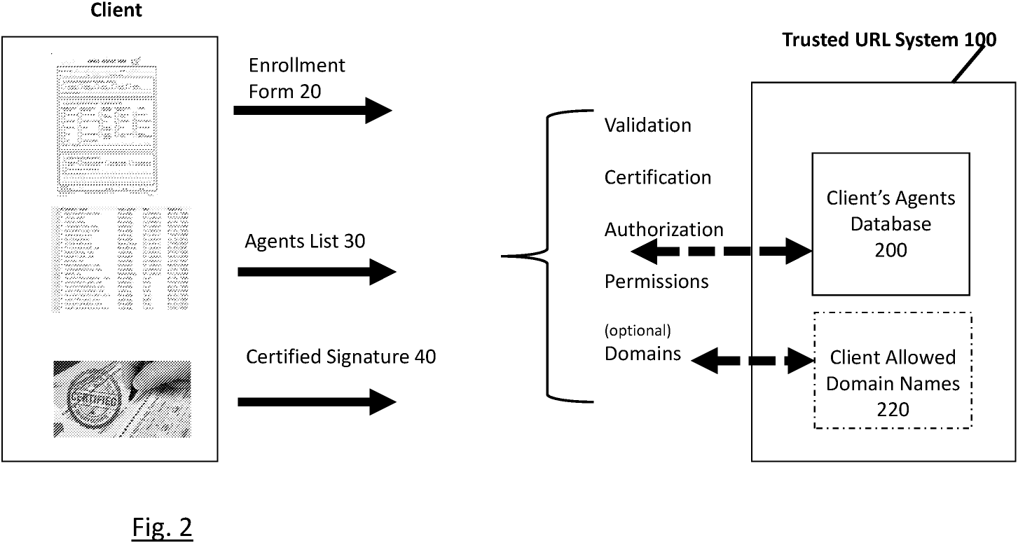

### FIG. 2

The client/agent enrolling process in which an organization enrolls as a client to the system and appoints agents authorized to act on its behalf.

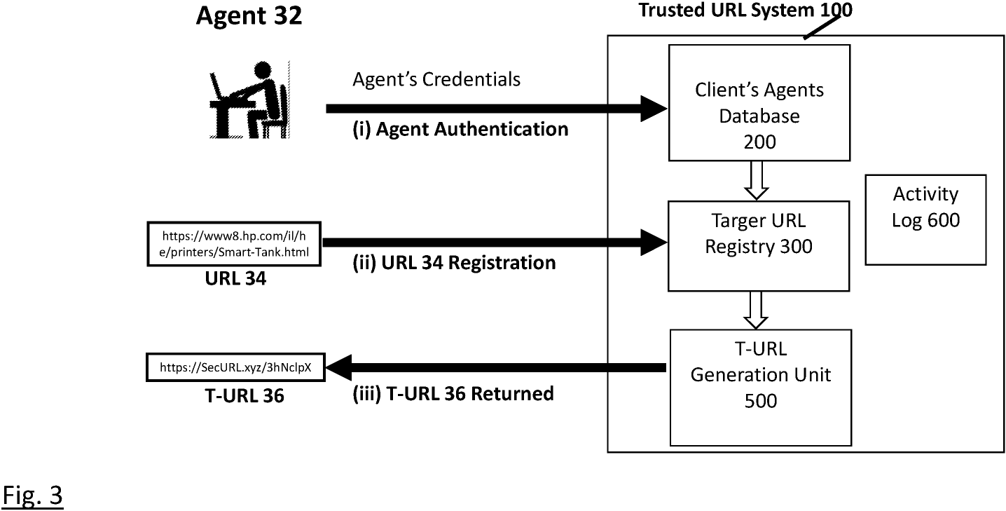

### FIG. 3

T-URL generating process in which said Client’s agent registers a target URL in Target-URL Registry 300 and receives a T-URL associated with that target URL to be redirected to the target URL’s internet address.

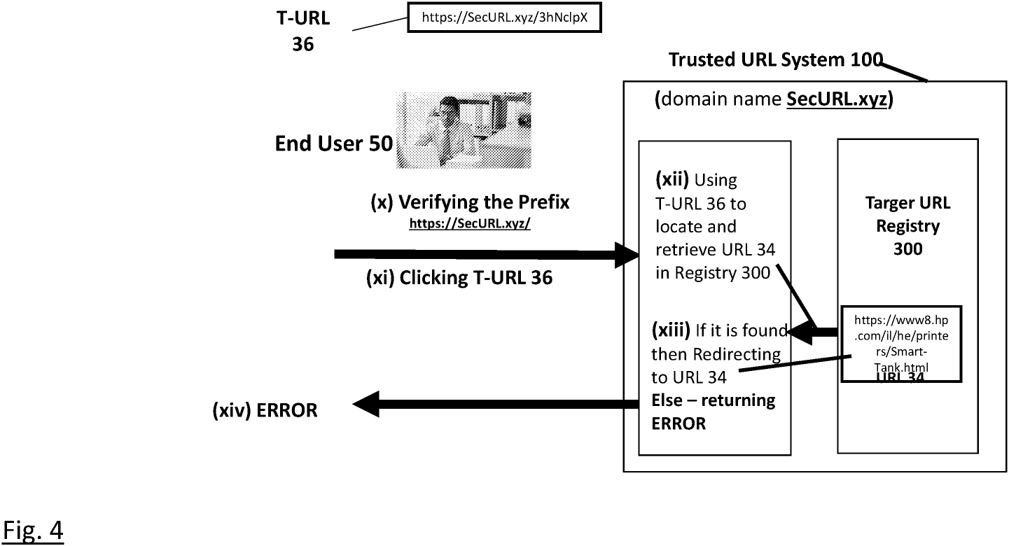

### FIG. 4

The redirection process in which the end-user clicks the T-URL sent to him, for example, by the Client, after verifying the T-URL’s domain name and is redirected to its associated target URL address.

### FIG. 5

A well-known problem utilized frequently by phishing attackers is to change the text part or the address part of a URL or to replace the text part with a picture. That way, the URL text or picture which is displayed to the end-user may seem innocent, while the underlying (sometimes hidden) address may be false and harmful. The present invention offers a workaround to this problem.

Reference is now made to FIG. 2:

The enrolment process requires the Client to fill in an enrollment form 20, which is then signed by a particular authorized officer or legal representative.

The process of signing 40 may be made for digital form documents by using a certified digital signature such as used by governmental, financial, or other establishments to identify legal entities.

Alternatively, a paper printout of the form may be signed in a traditional manner (e.g., using a stamp and seal).

The validation, authorization, and final certification may be made in whole or in part manually offline to complete the client enrolment.

The Agents List 30 includes all the persons/entities authorized by the Client to use system 100 on its behalf and may include other information for each agent, such as contact information (e.g.: phone number or e-mail address), a list of action permissions, and other required personal details. The Agents information is stored in Agents Database 200 along with his credentials and information required to authenticate the agents upon signing in, for the URL registration and management process, and any other interaction with the system.

In some embodiments of the invention, the Client could further preregister a list of owned or other domain names 220 and restrict the generation and redirection of T-URLs only to target URLs whose destination is under the preregistered domain names.

Reference is now made to FIG. 3:

Agent 32 intends (ii) to register a client’s URL 34 with Target-URL registry 300 of system 100, which in turn generates (iii) a T-URL 36 to be sent to end-users, thereby fortifying their confidence in the provided link.

The URL 34 registration process needs an authorized agent of an enrolled client to log-in to the system. Client’s Agent 32 is authenticated by System 100 and is required to provide Credentials (i). System 100 authenticates these credentials using the information stored in Client’s Agents database 200 and allows the agent to operate in accordance with the permissions the Client granted him (e.g.: registering Target URLs, managing other agents, managing expirations of URLs, etc.). Agents would be verified and authorized to log-in using any known user authentication method, using passwords, Public Key Digital Certificates, VPN, hardware or software tokens, e.g., Google Authenticator, cell phones, image, and biometric methods, or any other method, existing or to be developed, designed for unique identification of an entity as acceptable by any particular embodiment.

Optionally, URL 34 is checked against a list of domain names (220 in FIG. 2) allowed to be used by the Client. Basically, a client is allowed to create URLs within its controlled or owned domains, and others can’t. Nevertheless, any amendments to the aforesaid practice are considered to reside within the scope of the present invention.

Optionally, upon URL registration, a hash value of the target Internet resource addressed by URL 34 could be computed, e.g., using SHA-256 digital fingerprint algorithm, and stored in Target-URL registry 300 along with URL 34. Later, upon redirection to URL 34, the current resource’s recomputed hash value could be compared to the stored hash value to verify that the resource has not changed.

Thereafter, System 100 saves URL 34 in the Target-URL registry 300.

The T-URL Generation Unit 500 generates T-URL 36 from URL 34 just stored in URL registry 300. T-URL 36 may, for example, be obtained by using a URL shortening software package such as YOURLS (https://yourls.org/). T-URL 36 could comprise either numbers or any

string of characters allowed in a URL. Again it is emphasized that the generated T-URL’s string length is of no special importance, and the shortening software is used by system 100 just by way of example or as a matter of convenience.

In an embodiment, instead of logging-in, the agent may send (ii), e.g., via e-mail, a digitally signed request which includes URL 34. The generated T-URL 36 may be returned (iii) to the agent similarly.

Preferably, some or all activities along with the agent’s identity are recorded with a timestamp in an Activity Log 600.

Reference is now made to FIG. 4:

T-URL 36 may be communicated directly or indirectly by the Client or its agents or by System 100 to end-user 50, e.g., via e-mail or SMS messages. When clicked by end-user 50, T-URL 36 serves to locate and retrieve target URL 34 from Target URL registry 300 and to redirect the end-user to that target address.

One advantage of the present invention is that it gives the end-user peace of mind as to the legitimacy of the T-URL, as the registered URLs are being authenticated, and therefore the end-user is assured that the T-URL was created by a certified client’s agent and not by an impostor. Also, the Client is identifiable and may be held accountable for the T-URL.

As stated above, the only precaution the end-user 50 has to take is to verify

(x) that T-URL 36′s domain name is the well-known and trusted system 100′s domain name (e.g.: “securl.xyz”).

When T-URL 36 is clicked (xi), the DNS directs the request to system 100 hosted under its known and trusted domain name. In system 100, the redirection process is initiated, and T-URL 36 is used to locate and retrieve

(xii) its associated target URL 34 from Target-URL registry 300, and if it is found (xiii), end-user 50 is redirected to the target URL 34. Otherwise, end-user 50 receives an error indication (xiv).

In some embodiments, before redirection to URL 34, a hash value of the current target Internet resource addressed by URL 34 is first being calculated and checked against the hash value computed and recorded upon the registration process (FIG. 3 (ii)). A mismatch may indicate that the target resource has changed, and both end-user 50 and the Client may be warned, and the redirection process may be aborted.

In another embodiment of the present invention, system 100 could optionally scan the target URL addressed resource before redirection. The system may check it against a checklist for identity, malware, blacklists, or other required security components.

In some embodiments of the present invention, e.g., when a bulk of documents needs to be sent to respective customers, system 100 may allow a client’s computerized application to connect and perform the URL registration and T-URL generation process via a secured API. In such embodiments, the clients’ computerized system may, for example, be registered as an agent of the Client and assigned secured log-in credentials to the system, e.g. an associated private token or OTP etc.

Reference is now made to FIG. 5

A well-known phishing attack practiced frequently is changing the text part or the address part of a URL. Moreover, frequently the address part is “hidden” by a picture on which the end-user is requested to click. That way, a URL text or picture which is displayed to the end-user may seem innocent, while the underlying address may be false and harmful.

The present invention provides a safeguard to protect the end-user and enable verification that the user reached a safe place.

In an embodiment, End-user 50 may sign-up to system 100, which provides the user with a user code for identification. The user code may, for example, be stored in the browser’s local storage to relieve the need of retyping it time and again. The end-user may be requested to type a “secret phrase” of his choice that only the user and System 100 know. The information may be saved in end-users database 400 (see FIG. 1).

When T-URL 36 is clicked and reaches system 100′s redirection process, it is not immediately redirected to URL 34. Instead, a Web page such as the one shown in FIG. 5 displays, and end-user 50 is requested to take action, which may, for example, be one of the following:
1. If the user has signed-up to database 400, the browser local storage may be examined for the user code stored in local storage upon registration, and if it exists, then the corresponding “secret phrase” is fetched from user database 400 and displayed (1) so that the end- user can verify that he reached System 100 and not an impostor since only system 100 has this “secret phrase”; or
2. If system 100 has purchased a DV Certificate for its domain name (https://en.wikipedia.org/wiki/Domain-validated_certificate),
   e.g.: SecURL.xyz, then the user may check the padlock icon (3) to verify that the displayed Web Page′ DV Certificate has been issued to system 100′s domain name; or
3. The user is advised to verify the Web page’s address bar (2) for system 100’s domain name; or
4. System 100 may display a QR Code (not shown) which contains a digitally signed (with system 100’s private key) string comprising, for example, the current date and time. The end-user may download a simple application that scans the QR Code, and verifies the digital signature with system 100’s published public key, and displays the current date and time. If the verification fails, it displays an error indicating the end-user to abort the process.

If any of the above verification methods is positive, the user may press “Continue” to proceed with the redirection process. Otherwise, the user should press “Exit” to reach a safe place (e.g.: www.google.com) or close the Web page altogether.

It is emphasized that although reference is made herein to System 100 as a whole for clarity and convenience reasons, the various components it comprises may, in fact, function separately. For example, the redirection process (depicted in FIG. 4) could be separated from the generation process (depicted in FIG. 3), and the well-published trustworthy domain name may be associated with the redirection process while the URL registration process may be associated with a different domain name.

In the description and claims of the present application, each of the verbs, “comprise,” “include,” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood from the generic description of applicable systems illustrated in this specification or in the drawings.

In the claims, the word “comprising” does not exclude other elements or steps, and the indefinite article “a” or “an” does not exclude a plurality. A single processor, memory, firmware, software, or other unit or module may fulfill the functions of several items recited in the claims.

The mere fact that certain measures are recited in mutually different dependent claims does not indicate that a combination of these measures cannot be used to advantage.

The present technology is also understood to encompass the exact terms, features, numerical values or ranges, etc., if in here such terms, features, numerical values or ranges, etc. are referred to in connection with terms such as “about, substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A system for generating and using trusted URLs comprising client database, target URL registry, enrollment process module, generating process module and redirecting process module, wherein said enrollment process allows for adding verified entities to said client database that contains a list of agent entities, which are authorized to use said system on behalf of said client, and wherein said system authenticates said agents upon login to said system, and wherein said generating process receives a target URL input from an agent, stores it in said target URL registry, and generates a trusted URL output associated with said target URL, and wherein said redirecting process receives said trusted URL from an end-user, retrieves the associated target URL from said target URL registry, and redirects him to said associated target URL, and wherein said trusted URL is based on a well-known, published, trustworthy domain name, and wherein said domain name is associated with at least said redirection process module of said system.

2. The system for generating and using trusted URLs of claim 1, wherein said enrollment process defines or limit said agents’ permissions to use said system.

3. The system for generating and using trusted URLs of claim 2, wherein said agents’ permissions include at least one of the following: add agents, delete agents, generate trusted URLs, grant and limit permissions to agents, delete or expire trusted URLs and target URLs.

4. The system for generating and using trusted URLs of claim 1, wherein said agent entity is a computerized system and said authenticated login to the system is to an API.

5. The system for generating and using trusted URLs of claim 1, further comprising an end-user database.

6. The system for generating and using trusted URLs of claim 5 allowing for end-users to register to said end-user database and further communicate with said end-users.

7. The system for generating and using trusted URLs of claim 1, allowing to process data from said databases and provide information regarding the usage of certain URLs, domain names, agents, end-users, or any combination thereof.

8. The system for generating and using trusted URLs of claim 1, further comprising a list of pre-authorized domain names associated with said clients, and wherein said target URL’s domain name is required to be in said list.

9. The system for generating and using trusted URLs of claim 1, wherein said system further scans the Web resource addressed by said target URL and approves its security or safety.

10. The system for generating and using trusted URLs of claim 9 wherein said scan is made during said generating process, redirecting process, or any combination thereof.

11. The system for generating and using trusted URLs of claim 10 wherein said scan is made upon election of said end-user.

12. The system for generating and using trusted URLs of claim 1, wherein said redirection process module further performs a verification process, which allows end-users to verify that said trusted URL’s domain name is said trustworthy domain name and not an impostor’s, before allowing them to be redirected to said target URL.

13. The system for generating and using trusted URLs of claim 12, wherein said verification process displays a Web page to end-users allowing them to perform said verification and elect whether to proceed with the redirection to said target URL or to abort.

14. The system for generating and using trusted URLs of claim 13, wherein said Web page’s content is selected from enrollment, verification, instructions, advertising, scanning, or any combination thereof.

15. The system for generating and using trusted URLs of claim 1, further comprising a process of recording various events or activities performed by said agents along with time stamps in an activity log.

16. A method for generating and using trusted URLs comprising client database, target URL registry, enrollment process, generating process and redirecting process, wherein said enrollment process allows for adding verified entities to said client database that contains a list of agents, which are authorized to use a computerised environment system according to said method on behalf of said client, and wherein said system authenticates said agents upon login to said system, and wherein said generating process receives a target URL from an agent, stores it in said target URL registry, and generates a trusted URL associated with said target URL, and wherein said redirecting process receives said trusted URL from an end-user, retrieves the associated target URL from said target URL registry, and redirects him to said associated target URL, and wherein said trusted URL is based on a well-known, published, trustworthy domain name, and wherein said domain name is associated with at least said redirection process of said method.

17. The method for generating and using trusted URLs of claim 16, wherein said enrollment process defines or limit said agents’ permissions to use said method.

18. The method for generating and using trusted URLs of claim 17, wherein said agents’ permissions include at least one of the following: add agents, delete agents, generate trusted URLs, grant and limit permissions to agents, delete or expire trusted URLs and target URLs.

19. The method for generating and using trusted URLs of claim 16, wherein said agent entity is a computerized system and said authenticated login is to said system, server, API, database, Website, Web application or any combination thereof.

20. The method for generating and using trusted URLs of claim 16, further comprising the use of an end-user database.

21. The method for generating and using trusted URLs of claim 20 allowing for end-users to register to said end-user database and further communicate with said end-users.

22. The method for generating and using trusted URLs of claim 16, allowing to process data from said databases and provide information regarding the usage of certain URLs, domain names, agents, end-users, or any combination thereof.

23. The method for generating and using trusted URLs of claim 16, further comprising a client related list of pre-authorized domain names and wherein said target URL’s domain name is required to be in said list.

24. The method for generating and using trusted URLs of claim 16, wherein said method is designed to further scan the Web resource addressed by said target URL and approve its security and safety.

25. The method for generating and using trusted URLs of claim 24 wherein said scan is made during said generating process, redirecting process, or any combination thereof.

26. The method for generating and using trusted URLs of claim 25 wherein said scan is made upon election of said end-user.

27. The method for generating and using trusted URLs of claim 16, wherein said redirection process further performs a verification process, which allows end-users to verify that said trusted URL’s domain name is said trustworthy domain name and not an impostor’s, before allowing them to be redirected to said target URL.

28. The method for generating and using trusted URLs of claim 27, wherein said verification process displays a Web page to end-users allowing them to perform the verification and elect whether to proceed with the redirection to said target URL or to abort.

29. The method for generating and using trusted URLs of claim 28, wherein said Web page’s content is selected from enrollment, verification, instructions, advertising, scanning, or any combination thereof.

30. The method for generating and using trusted URLs of claim 16, further comprising a process of recording various events or activities performed by said agents along with a time stamps in an activity log.
